(19) United States
(12) Patent Application Publication
(10) Pub. No.: US 2004/0076789 A1
(43) Pub. Date: Apr. 22, 2004

(54) Magnetic recording medium having embedded information for contents management, storage type magnetic recording apparatus mounting such a medium, and method thereof

(76) Inventors: Takuya Ono, Nagano (JP); Kiminori Sato, Nagano (JP)

Correspondence Address: ROSSI & ASSOCIATES, P.O. BOX 826, ASHBURN, VA, 20146-0826, US

(21) Appl. No.: 10/622,069

(22) Filed: Jul. 17, 2003

(30) Foreign Application Priority Data
Jul. 17, 2002 (JP) 2002-207697

(51) Int. Cl. B32B 3/02

(52) U.S. Cl. 428/65.3; 428/694 SG; 428/694 R

(57) ABSTRACT

A magnetic recording medium embeds contents management information for managing utilization forms of the contents to prevent illegal access while allowing various forms of contents. The recording medium has a region for embedding its track ID. A pattern corresponding to copy or period management information, which is a type of contents management information, as well as a pattern corresponding to track ID that is a code unique to each track can be embedded in the region. The pattern of contents management information can be included at every track by classification using a Gray code, for example.

### BACKGROUND

An information distribution system of an information contents storage type that employs large capacity communication system and a magnetic recording apparatus in distributing information contents in a network communication is being studied. Such a system transmits and stores high quality and massive amount of information. Accordingly, the system needs high security to prevent illegal use, including manipulation and copying.

A management method, wherein an ID is set for each content, has been conventionally used for protecting information contents against illegal use. Specifically, information contents having an ID code is distributed only to permitted users to make the contents available. A drawback of this system is that illegal use is possible by transferring the ID code to a third party. In this respect, a system to avoid illegal use can be achieved by user management using communication in addition to using the contents ID. In an existing example of such a system, an electronic signature is sent through communication to allow only a permitted user to decrypt information contents and to use the contents.

Development and standardization of systems utilizing a communication system are proceeding to attain security, as mentioned above. They, however, perform ID management means using software. On the other hand, a decisive means does not exist for improving security of a magnetic recording apparatus, namely a storage system. A storage type information distribution system can support various utilization forms, such as a copying form, for various users in addition to permission of utilization. When all the utilization forms are managed through a communication system, there arise the risks of a third party manipulating and illegally copying during the communication phase. This is problematic in the conventional system.

Accordingly, there remains a need for a magnetic recording medium and a storage type magnetic recording apparatus that provide security measures to prevent illegal use of the information while allowing various forms of utilization of the contents. The present invention addresses this need.

### SUMMARY OF THE INVENTION

The present invention relates to a magnetic recording medium having embedded contents management information for managing utilization forms of the contents, a storage type magnetic recording apparatus containing such a medium, and a method of controlling use of encrypted information contents. The present invention is particularly useful for improving security of the contents and for preventing illegal use.

One aspect of the present invention thus is a magnetic recording medium that has a magnetic disk with embedded data patterns that include a pattern corresponding to contents management information, which can be copy management information for managing copying of contents or period management information for managing utilization period of contents. The pattern corresponding to contents management information can be provided on every track.

The magnetic disc can be formed of a nonmagnetic substrate having a portion with pits formed on the surface thereof, and a magnetic layer formed over the surface of the substrate. Each of the data pattern can be embedded by forming a pattern of the pits on a nonmagnetic substrate and selectively magnetizing the magnetic layer at the pattern of the pits.

Another aspect of the present invention is a storage type magnetic recording apparatus that incorporates the above magnetic recording medium. The magnetic recording medium can store the contents obtained through broadcasting or communication on a track having the copy management information corresponding to a copying form or the period management information corresponding to a utilization period that is permitted by a distributor of the contents or for a user of the contents.

The magnetic recording apparatus can further include means for encrypting output of the contents after confirming that a copying form is permitted by a definition of the copy management information on the track that stores the contents to be used. It can further include means for decrypting the contents after confirming that a utilization time is within a utilization period permitted by a definition of the period management information on the track that stores the contents to be used.

Another aspect of the present invention is a method of controlling use of encrypted information content, which includes providing the above described magnetic disk and receiving and storing the encrypted information contents obtained through broadcasting or communication on the track having the copy or period management information corresponding to a copying form or a utilization period that is permitted by a distributor or permitted for user of the contents.

The method can include encrypting output of the contents after confirming that a copying form is permitted by a definition of the copy management information on the track that stores the contents to be used. The method can include decrypting the contents after confirming that the utilization time is within a utilization period permitted by a definition of the period management information on the track that stores the contents to be used.

### BRIEF DESCRIPTION OF THE DRAWINGS

FIG. 1 schematically illustrates an example of a storage type magnetic recording apparatus.

FIGS. 2A-2D schematically illustrate the procedures for embedding information by mechanical patterning in a magnetic recording medium according to the present invention.

FIG. 3 is a partial plan view schematically illustrating regions of embedded data patterns of a magnetic recording medium according to the present invention.

FIG. 4 schematically illustrates a configuration of an embedded pattern of copy management information in a magnetic recording medium according to the present invention.

FIG. 5 schematically illustrates an embodiment of an information distribution system according to the present invention, where the user is allowed to use the information contents only in the copying form permitted by the distributor of the information contents.

FIG. 6 schematically illustrates an embodiment of an information distribution system according to the present invention, where the user combines the user ID and the copy management information and sends to the distributor, allowing the user to use the information content only in the copying form permitted for the user.

FIG. 7 schematically illustrates an embodiment of an information distribution system according to the present invention, where the user ID and the copy management information are combined in the storage type magnetic recording apparatus and sent to the distributor, allowing the user to use the contents only in the copying form permitted for the user.

FIG. 8 schematically illustrates a configuration of an embedded pattern of period management information according to the present invention.

FIG. 9 schematically illustrates an embodiment of an information distribution system according to the present invention, where the user is allowed to use the information contents only in the utilization period permitted by the distributor.

FIG. 10 schematically illustrates an embodiment of an information distribution system according to the present invention, where the user combines the user ID and the period management information and sends to the distributor, allowing the user to use the contents only within the utilization period permitted for the contents user.

FIG. 11 schematically illustrates an embodiment of an information distribution system according to the present invention, where the user ID and the period management information are combined in a storage type magnetic recording apparatus and sent to the distributor, allowing the user to use the information contents only within the utilization period permitted for the user.

### DETAILED DESCRIPTION

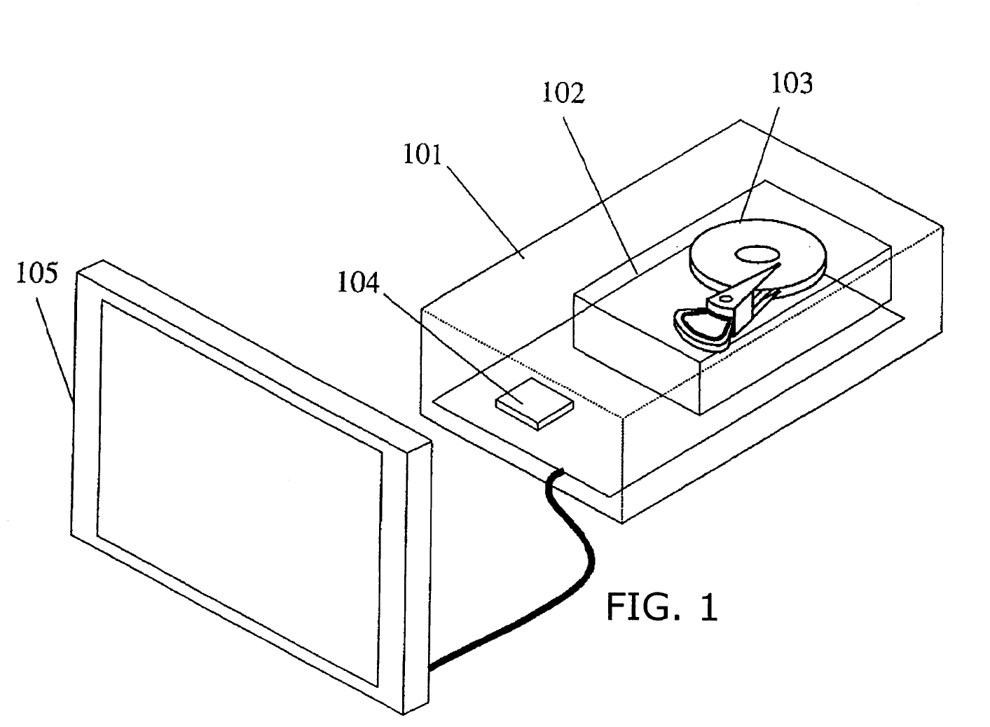

FIG. 1 illustrates an example of a copy management device for managing copying of the contents stored in a storage type magnetic recording apparatus 101, which includes a magnetic disk drive 102 comprised of at least one magnetic recording medium 103 having security information embedded as a data pattern. The recording apparatus 101 comprises LSI 104 for encrypting/decrypting the information contents and connecting to a playback device 105. Japanese Unexamined Patent Application Publication No. H6-68444 or No. H7-153047, or co-pending U.S. patent application identified as FUJI:262, filed Jul. 15, 2003, for instance, can be used for embedding data pattern in the magnetic recording medium 103. The disclosures of these references are incorporated herein by reference.

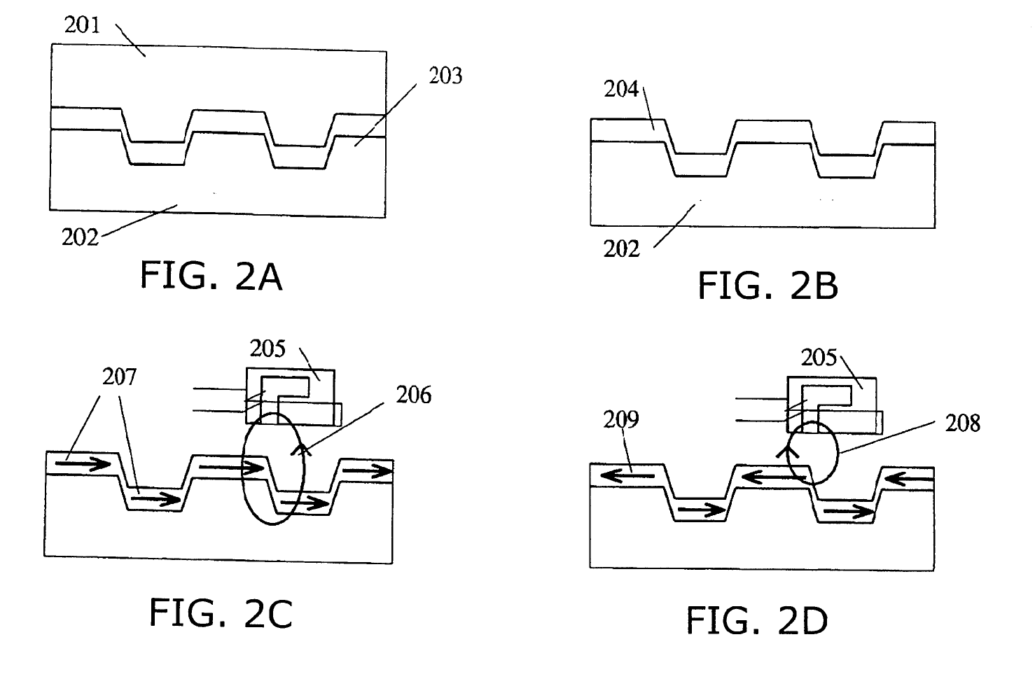

A magnetic pattern can be formed, as shown in FIG. 2A, by forming an uneven pattern 203 with pits formed in the surface of a nonmagnetic substrate 202 with a patterned stamper 201, as shown in FIG. 2B, depositing a magnetic layer 204 on the substrate, as shown in FIG. 2C, magnetizing 207 the entire magnetic layer by a magnetic field 206 generated by a magnetic head 205, and as shown in FIG. 2D, selectively magnetizing 209 only the uppermost part of the surface by a magnetic field 208 weaker than the magnetic field 206 used in the primary magnetization step. The thus formed pattern, being mechanically formed on the substrate, is embedded information that cannot be changed by a magnetic head.

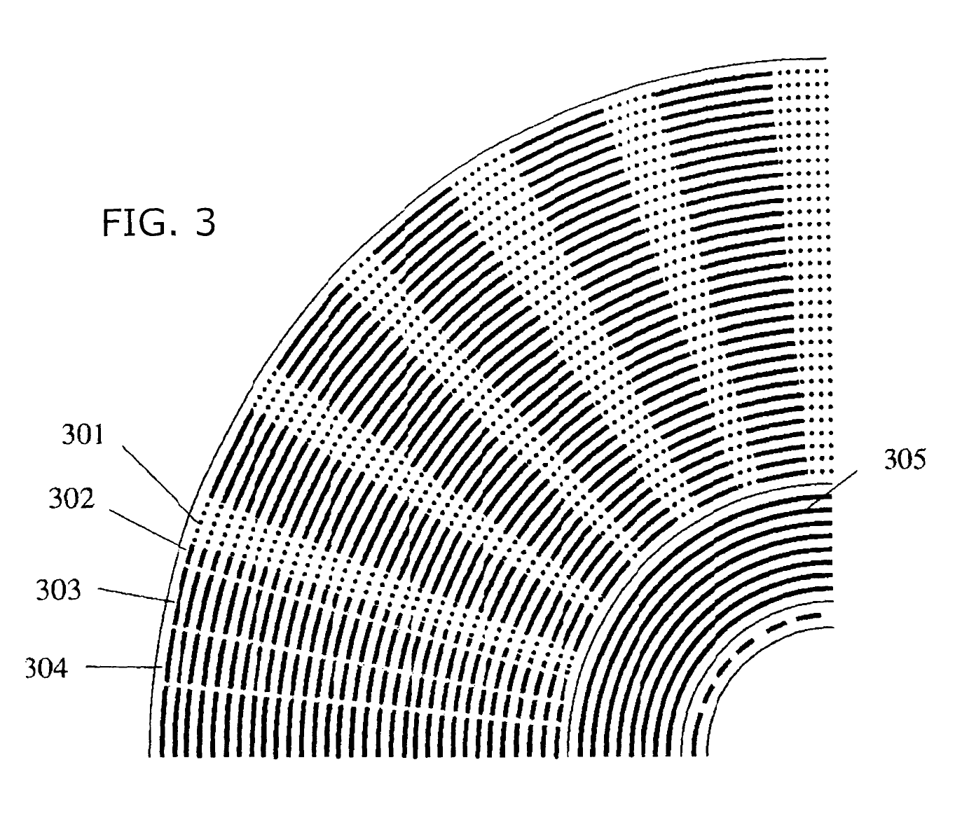

FIG. 3 schematically shows regions of embedded data patterns of a magnetic recording medium. Following the above described method, servo information, track ID, and medium ID can be embedded respectively in a region 303 for embedding servo information, a region 304 for embedding track ID, and a region 305 for embedding medium ID. In FIG. 3, the reference numeral 301 indicates a region for recording contents, and 302 indicates a region for recording contents ID and contents meta-information. The region allows writing in by a magnetic head.

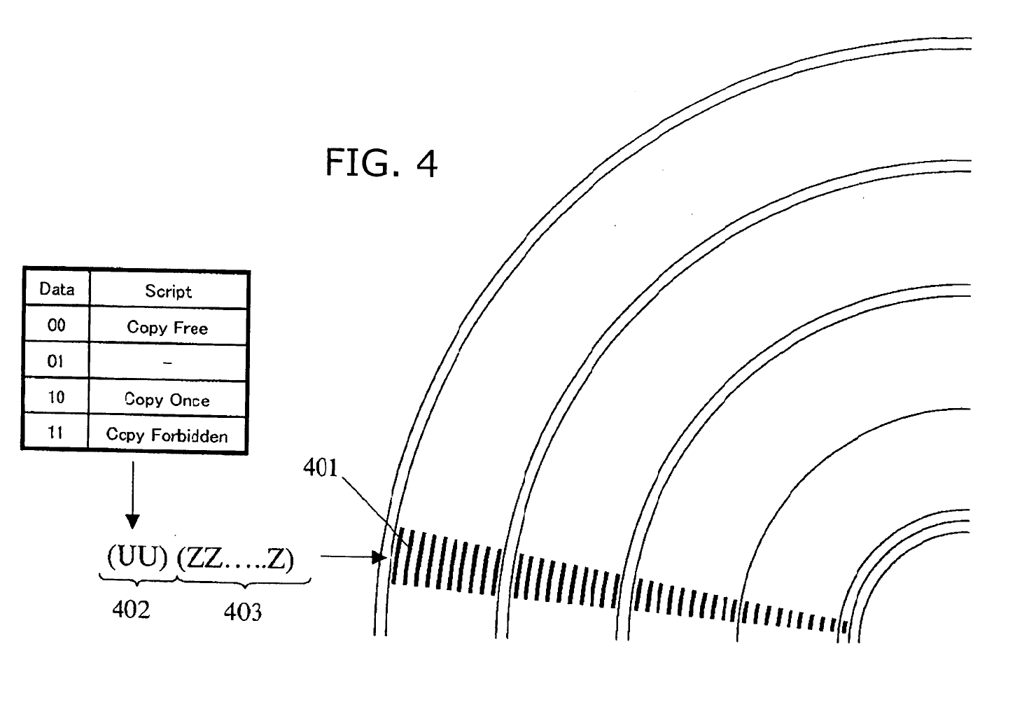

FIG. 4 illustrates details of the track ID. In this embodiment, a region 401 (region 304 in FIG. 3) for embedding the track ID of embedded patterns includes a pattern 403 corresponding to the track ID that is a unique code to each track and a pattern 402 corresponding to the copy management information that is a type of contents management information. The pattern 402 corresponding to the copy management information is set at each track by classification using a Gray code, for example, as shown in FIG. 4.

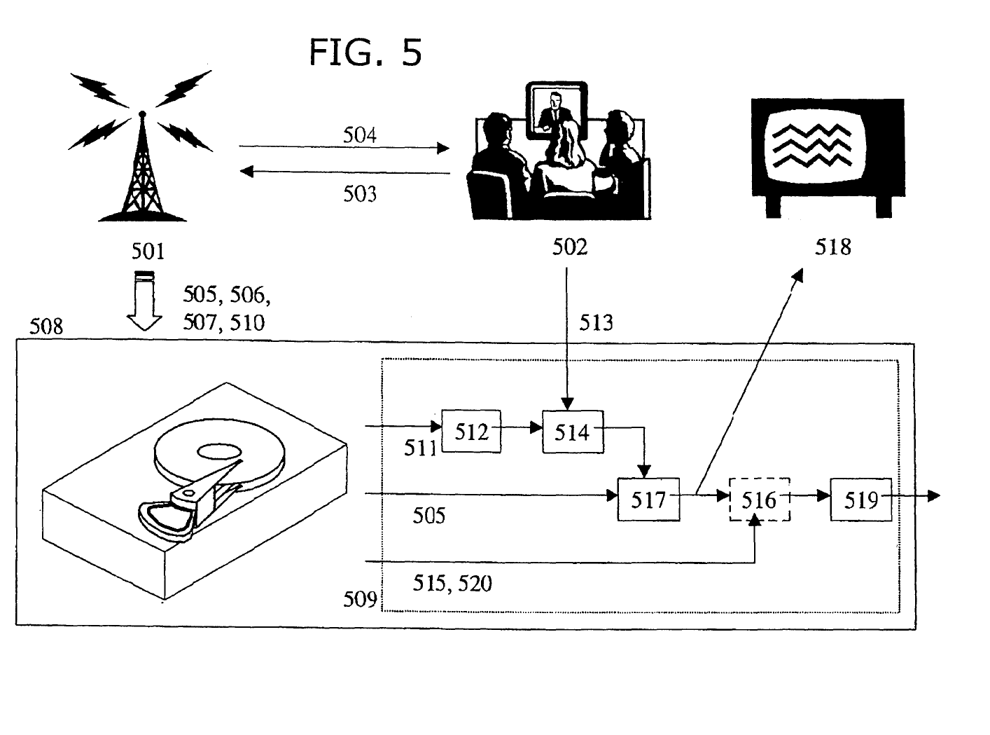

FIG. 5 shows an embodiment of an information distribution system using the above-described storage type magnetic recording apparatus. In the distribution system of FIG. 5, the user 502 is allowed to copy the encrypted information contents 505 only in the form permitted by the information contents distributor 501. The user 502 sends a request 503 to the contents distributor 501 to distribute information contents 505. When the distributor 501 receives a distribution request 503 from the user 502, the distributor charges 504 the user 502 a fee. At the same time, the distributor 501 distributes encrypted information contents 505 through broadcasting or communication to a storage type magnetic recording apparatus 508.

The information contents 505 is attached with a contents ID 506 unique to the contents and contents meta-information 507 storing an attribute of the contents and utilization form. The distributor 501 distributes the contents attaching information 510 of copy permission form as a part of the contents meta-information 507, for example.

The storage type magnetic recording apparatus 508 stores the information contents 505 on a track that has the pattern of copy management information 402 (FIG. 4) corresponding to the distributed information of copy permission form 510. The recording apparatus has means for encrypting and decrypting the information content 505. For instance, when the information contents 505 is used, the encryption and decryption device 509 (e.g., LSI) can conducts verification 512 whether the copy is legally obtained by referring to the medium ID 511 and then, verification 514 whether the use is with permission, i.e., checks whether the user is an authorized party, referring to the user ID 513 given by the user 502. After conducting the verification, the information contents 505 are decrypted 517, to allow the user 502 to play 518 the contents.

When the user 502 copies the contents 505, after the copy utilization form is verified to be the one permitted by the distributor 501, referring to the copy management information 520, the information contents 505 is encrypted 519 and output. A system for encrypting 519 the contents can be different from the contents encryption system employed during distribution. Alternatively, the encrypted information contents 505 before decryption 517 can be directly output.

Alternatively, referring to FIGS. 4 and 5, the copy management information can be coded as a part of a track ID 515, as opposed to embedding a pattern 402 of copy management information in the region 401 for embedding the track ID separately from the track ID pattern 403.

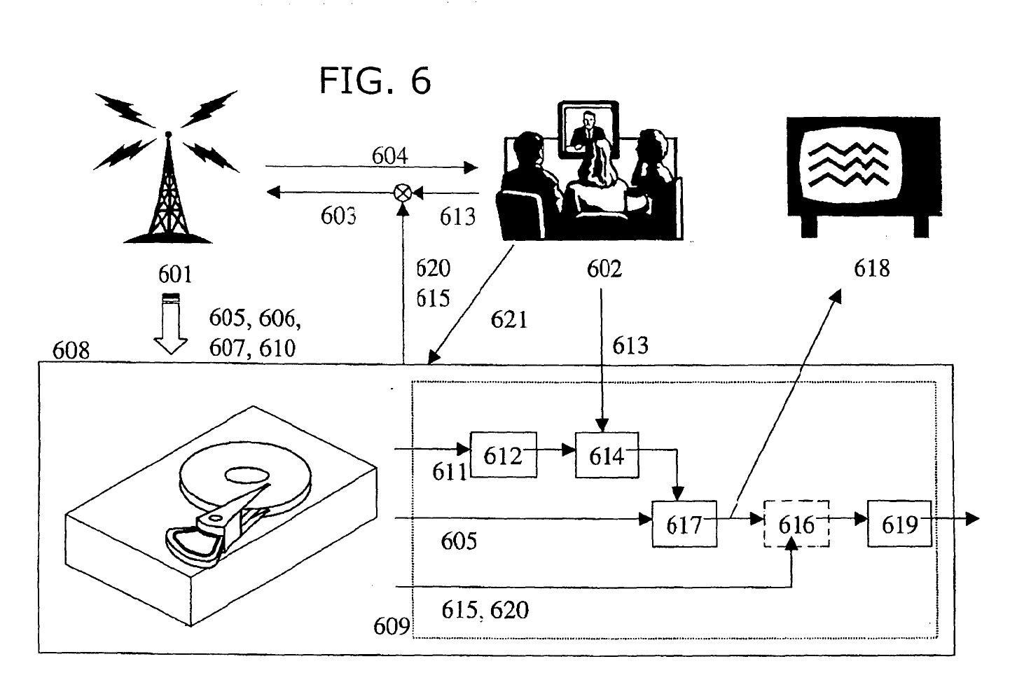

FIG. 6 shows another embodiment of an information distribution system. In this embodiment, the encrypted information contents 605 can be copied only in the copying form permitted for the user 602. The storage type magnetic recording apparatus 608, and the embedded pattern and the embedding means into the magnetic recording medium mounted on the recording apparatus are the same as in the previous embodiment (FIG. 5).

When the user 602 sends a request 603 to the distributor 601 to distribute information contents, a request 621 for the copying form desired by the user is transmitted to the storage type magnetic recording apparatus 608. The storage type magnetic recording apparatus 608 sends back copy management information 620 or a track ID 615 including the copy management information, corresponding to the request 621 for the desired copying form to the user 602. The contents user 602 transmits to the distributor 601 a distribution request 603 combining the user ID 613 and returned copy management information 620 or track ID 615. Where each user 602 holds a storage type magnetic recording apparatus 608, the user ID 613 and the copy management information 620 can be combined within the storage type magnetic recording apparatus 608.

The distributor 601 charges 604 the user 602 a fee set according to the requested type of contents and desired copying form information sent from the user. The request 621 of the desired copying form can be sent in an encrypted form using public key cryptography. The distributor 601 decrypts using a secret key to obtain a request 621 of desired copying form. This way, even if a third party knows the correspondence between the encrypted transmission data and its content, that is a desired copying form, decryption becomes very difficult since secret key is not available to the third party. Consequently, the user ID 613 is kept secured.

On receipt of the distribution request 603, the distributor 601 distributes encrypted information contents 605 to the storage type magnetic recording apparatus 608. The storage type magnetic recording apparatus 608 stores the information contents 605 on the track having the pattern 402 (FIG. 4) of copy management information that corresponds to the transmitted request 621 of desired copying form. In this process, either of the two ways can be employed: information 610 of copy permission form can be distributed and stored in the storage type magnetic recording apparatus 608 on the corresponding track; or a track ID 615 can be distributed and the track can store the contents.

Using the information contents 605 is the same as described previous with respect to the use of the embodiment of FIG. 5. The elements labeled 606, 607, 609, 612, 614, 616, 617, 618, and 619 correspond respectively to elements 506, 507, 509, 512, 514, 516, 517, 518, and 519 described with respect to FIG. 5.

Moreover, addition of request of desired copying form in the event of distribution request for information contents can be conducted in the side of the user. Where a plurality of users share a storage type magnetic recording apparatus, the addition process of request of desired copying form to the distribution request can be conducted in the common storage type magnetic recording apparatus.

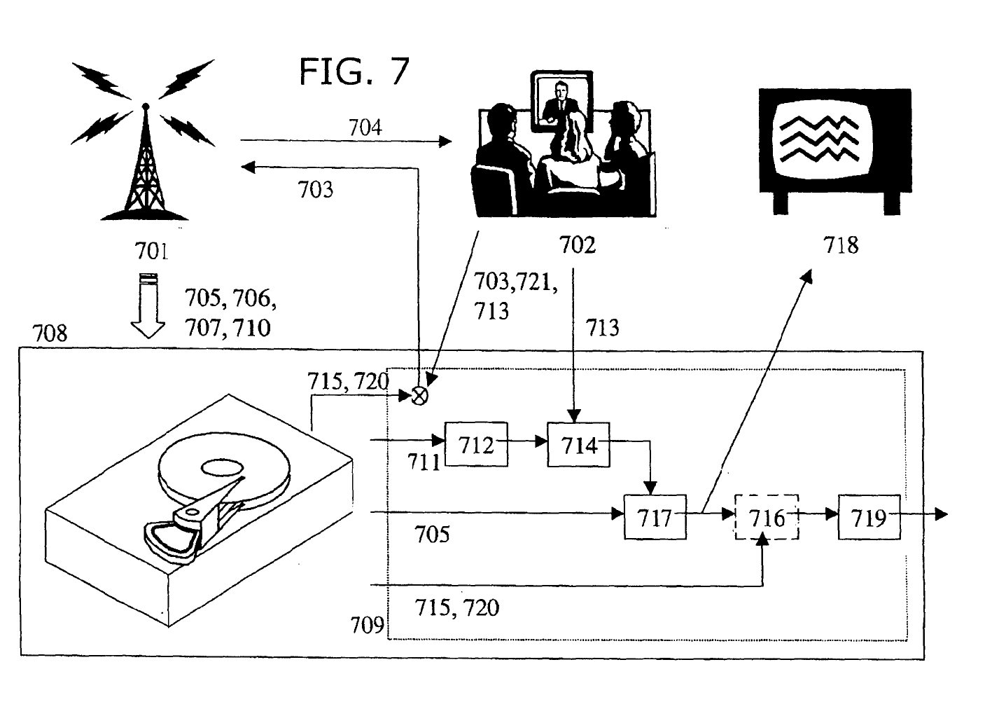

FIG. 7 shows another embodiment of an information distribution system. In this embodiment, the storage type magnetic recording apparatus 708 sends the distribution request 703 and the request 721 of user's desired copying form to the distributor 701. Here, the encrypted information contents 705 are allowed to be copied only in a permitted copying form. The user 702 first sends the distribution request 703, the request 721 of desired copying form, and the user ID 713 to the storage type magnetic recording apparatus 708. The storage type magnetic recording apparatus 708 combines the user ID 713 sent from the user 702 and copy management information 720 corresponding to the request 721 of desired copying form, or a track ID 715 including the copy management information, and sends to the distributor 701, to perform the user's distribution request 703.

Using the information contents 705 is the same as described previous with respect to the use of the embodiment of FIG. 5. The elements labeled 706, 707, 709, 712, 714, 716, 717, 718, and 719 correspond respectively to elements 506, 507, 509, 512, 514, 516, 517, 518, and 519 described with respect to FIG. 5.

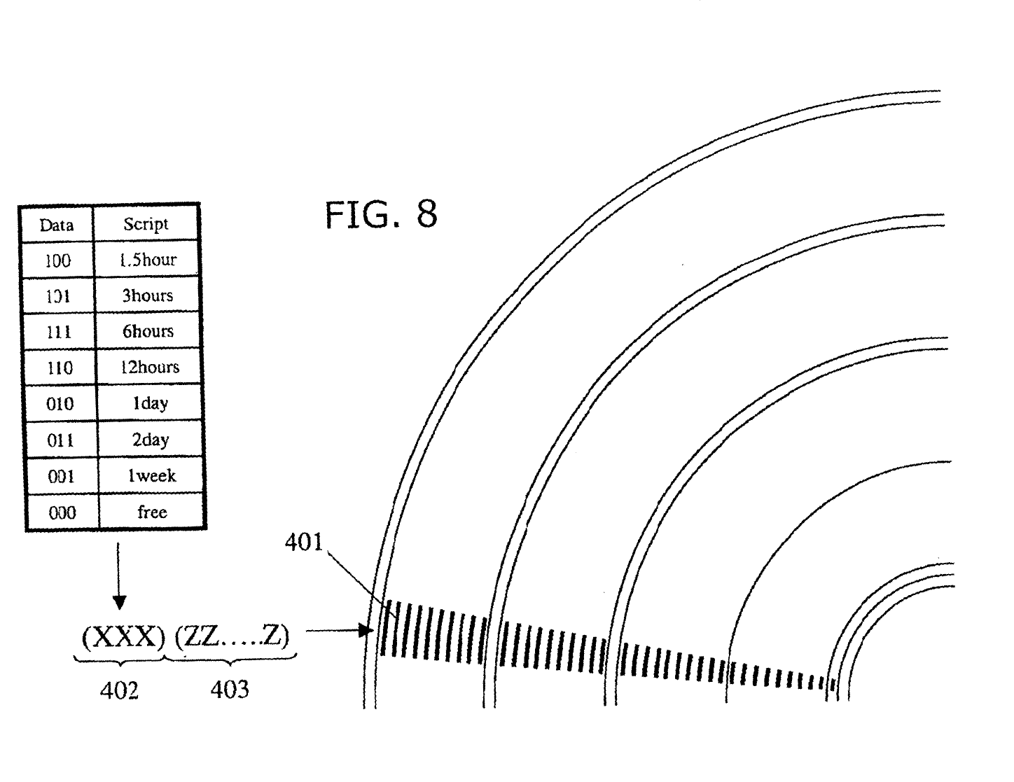

According to another aspect of the present invention, the period of use can be managed. Referring to FIGS. 1 to 3, the magnetic recording medium is similar to that previously disclosed above. FIG. 8 illustrates the details of track ID. In the region 401 (304 in FIG. 3) for embedding a track ID of embedded patterns, a pattern 402 corresponding to period management information, which is a kind of contents management information, is embedded as well as a pattern 403 corresponding to the track ID, which is a code unique to each track. This pattern 402 of period management information is set on every track by classification using the Gray code, for example, as shown in FIG. 8.

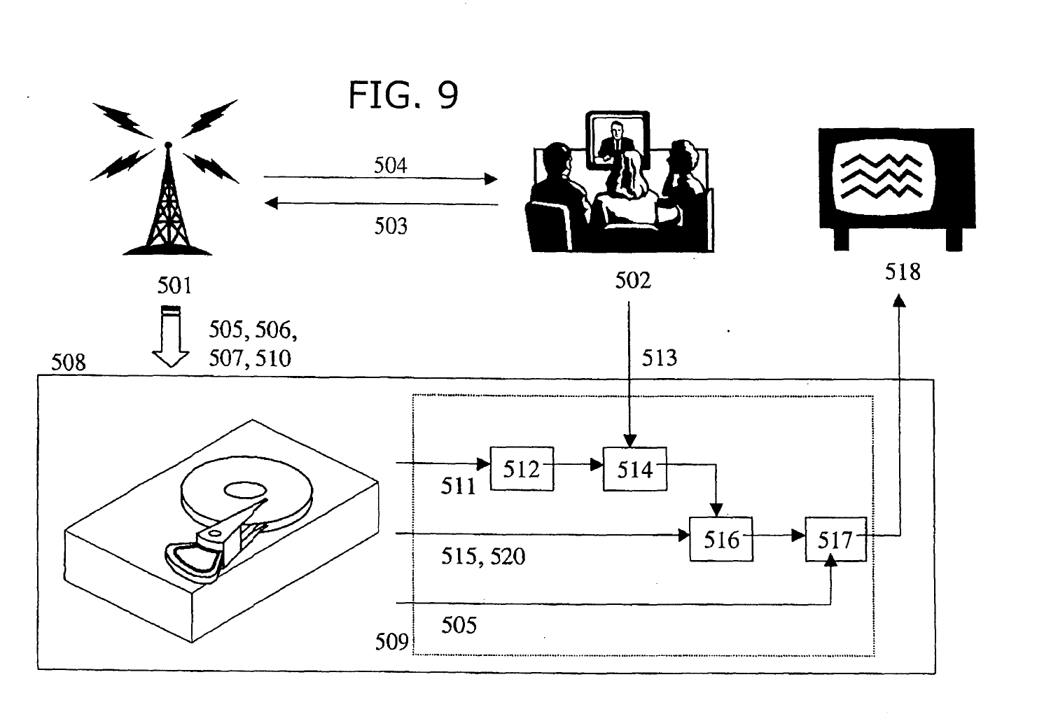

FIG. 9 shows an embodiment of an information distribution system using above-described storage type magnetic recording apparatus. This embodiment is similar to the embodiment of FIG. 5, but permits the information contents 505 to be used only during the period permitted by the distributor 501 of the information contents. The user 502 sends a request 503 for distribution of information contents 505 to the distributor 501. On receiving the distribution request 503 from the user 502, the distributor 501 charges 504 the user 502 a fee. At the same time, the distributor 501 distributes encrypted information contents 505 through broadcasting or communication to the storage type magnetic recording apparatus 508. The information contents 505 are attached with a contents ID 506 that is unique to the contents and contents meta-information storing attribute of the contents and utilization form. The contents distributor 501 distributes the contents attaching permitted utilization period information 510 as a part of the contents meta-information 507.

The recording apparatus 508 stores the information contents 505 on a track having the pattern 402 (FIG. 8) of period management information corresponding to the transmitted information 510 of permitted utilization period. On utilization of the information contents 505, the encryption and decryption LSI 509 verifies 512 whether the copy is legally obtained by referring to the medium ID 511 and verifies 514 whether the use is with permission, i.e., checks whether the user is an authorized party, referring to the user ID 513 given by the user 502. After confirming 516 that the period is within the permitted utilization period, referring to the period management information 520, the information contents 505 are readout and decrypted 517 to allow the user to play 518 the contents.

Alternatively, instead of embedding the pattern 402 of period management information in a region 401 for recording track ID separately from the track ID pattern 403, the period management information can be coded as a part of the track ID.

The embodiments previously disclosed in FIGS. 5, 6, and 7 also can further incorporate the period of use management. Specifically, after confirming 516, 616, 716 (illustrated in phantom) that the period is within the permitted utilization period, referring to the period management information 520, 620, 720 (or the track ID 515, 615, 715), the decrypted information contents 505 can be encrypted 519, 619, 719 and output.

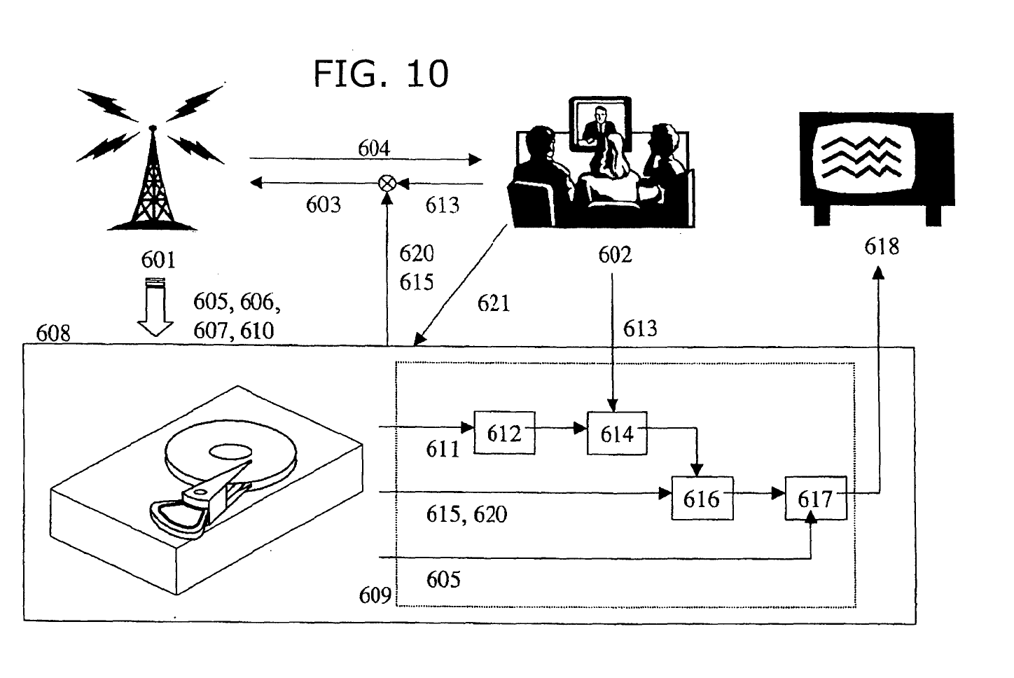

FIG. 10 shows another embodiment of an information distribution system. This embodiment is similar to the embodiment of FIG. 6 but allows the information contents 605 to be used only during the period permitted for the user 602 as in the embodiment of FIG. 9. The storage type magnetic recording apparatus 608, and the embedded pattern and the embedding means into the magnetic recording medium mounted on the recording apparatus are the same as in the embodiment of FIG. 9.

When the user 602 sends a request 603 to the distributor 601 to distribute information contents, a request 621 for the utilization period desired by the user is transmitted to the storage type magnetic recording apparatus 608. The recording apparatus 608 sends back the period management information 620 or the track ID 615 including the period management information, corresponding to the request 621 for the desired utilization period to the user 602. The user 602 transmits to the distributor 601 the distribution request 603 combining the user ID 613 and returned period management information 620 or the track ID 615. Where each user 602 holds a separate storage type magnetic recording apparatus 608, the user ID 613 and the period management information 620 can be combined within the recording apparatus 608.

The distributor 601 can charge 604 the user 602 a fee according to the requested type of contents and the desired utilization period information sent from the user. The request 621 of the desired utilization period is sent in an encrypted form using public key cryptography. The distributor 601 decrypts using a secret key to obtain the request 621 of desired utilization period. This way, even if a third party knows the correspondence between the encrypted transmission data and its contents, that is the desired utilization period, decryption is made difficult since the secret key is not available to the third party. Consequently, the user ID 613 can be maintained secure.

On receipt of the distribution request 603, the distributor 601 distributes encrypted information contents 605 to the recording apparatus 608. The recording apparatus 608 stores the information contents 605 on the track having the pattern 402 (FIG. 8) of period management information that corresponds to the transmitted request 621 of desired utilization period. In this process, either of the two ways can be employed: information 610 of permitted utilization period can be distributed and the storage type magnetic recording apparatus 608 can be stored in the corresponding track; or a track ID 615 can be distributed and the track can store the content.

Using of the information contents is the same as the embodiment of FIG. 9. The elements labeled 612, 614, 616, 617, and 618 correspond respectively to elements 512, 514, 516, 517, and 518 described with respect to FIG. 9.

Moreover, addition of request of desired utilization period in the event of distribution request for information contents can be conducted on the side of the user. Where a plurality of users share a storage type magnetic recording apparatus, addition process of request of desired utilization period to the distribution request can be conducted in the common storage type magnetic recording apparatus.

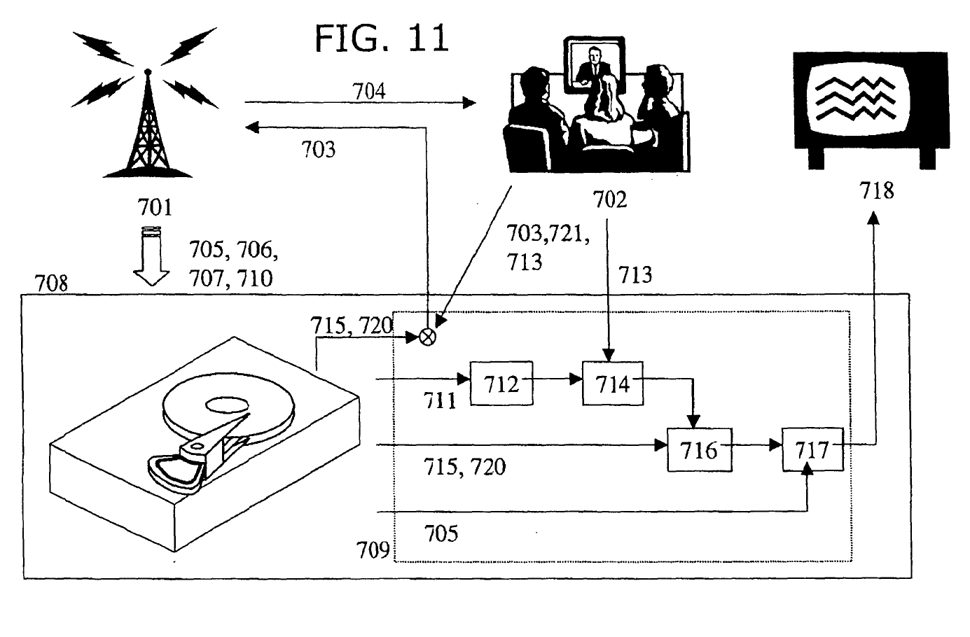

FIG. 11 shows another embodiment of an information distribution system in which a storage type magnetic recording apparatus 708 sends a distribution request 703 and a request 721 of desired utilization period of the user 702 to the distributor 701. This embodiment is similar to the embodiment of FIG. 7, but allows the information contents 705 to be used only within the permitted utilization period. The user 702 first sends the distribution request 703, the request 721 of desired utilization period, and the user ID 713 to the recording apparatus 708. The recording apparatus 708 combines the user ID 713 sent from the user 702 and the period management information 720 corresponding to the desired utilization period, or the track ID 715 including the information, and sends to the distributor 701, to perform distribution request 703 of the user.

The distribution, storing, and utilization of the information contents are the same as in the embodiments of FIGS. 9 and 10. The elements labeled 712, 714, 716, 717, and 718 correspond respectively to elements 512, 514, 516, 517, and 518 described with respect to FIG. 9.

Embedding of information pattern can be performed by means other than mechanically forming the pattern on a substrate.

In the present invention as described above, contents management information can be managed by hardware. Consequently, resistance to manipulation in the management of the invention is tougher than conventional software management. By providing contents management information on every track, in particular, combining with track ID, resistance to manipulation can be further improved.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosure of the priority application, JP PA 2002-207697, in its entirety, including the drawings, claims, and the specification thereof, is incorporated herein by reference.

What is claimed is:

1. A magnetic recording medium comprising:
a magnetic disk with embedded data patterns that include a pattern corresponding to contents management information.

2. A magnetic recording medium according to claim 1, wherein the pattern corresponding to contents management information is provided on every track.

3. A magnetic recording medium according to claim 1, wherein the magnetic disk comprises a nonmagnetic substrate having a portion with pits formed on the surface thereof, and a magnetic layer formed over the surface of the substrate, each of the data pattern being embedded by forming a pattern of the pits on a nonmagnetic substrate and selectively magnetizing the magnetic layer at the pattern of the pits.

4. A magnetic recording medium according to claim 1, wherein the contents management information is copy management information for managing copying of contents.

5. A magnetic recording medium according to claim 1, wherein the contents management information is period management information for managing utilization period of contents.

6. A storage type magnetic recording apparatus comprising a magnetic recording medium defined by claim 4, wherein the magnetic recording medium stores the contents obtained through broadcasting or communication on a track having the copy management information corresponding to a copying form that is permitted by a distributor of the contents or for a user of the contents.

7. A storage type magnetic recording apparatus according to claim 6, further including means for encrypting output of the contents after confirming that a copying form is permitted by a definition of the copy management information on the track that stores the contents to be used.

8. A storage type magnetic recording apparatus comprising a magnetic recording medium defined by claim 5, wherein the magnetic recording medium stores the contents obtained through broadcasting or communication on a track having the period management information corresponding to a utilization period that is permitted by a distributor of the contents or for the user of the contents.

9. A storage type magnetic recording apparatus according to claim 8, further including means for decrypting the contents after confirming that a utilization time is within a utilization period permitted by a definition of the period management information on the track that stores the contents to be used.

10. A method of controlling use of encrypted information contents comprising the steps of:
providing a magnetic disk with embedded data patterns that include a pattern corresponding to one of copy management information for managing copying of contents and period management information for managing utilization period of contents; and
receiving and storing the encrypted information contents obtained through broadcasting or communication on a track having the copy or period management information corresponding to a copying form or a utilization period that is permitted by a distributor or permitted for user of the contents.

11. A method according to claim 10, further including the step of encrypting output of the contents after confirming that a copying form is permitted by a definition of the copy management information on the track that stores the contents to be used.

12. A method according to claim 10, further including the step of decrypting the contents after confirming that the utilization time is within a utilization period permitted by a definition of the period management information on the track that stores the contents to be used.
